(19) United States
(12) Patent Application Publication
(10) Pub. No.: US 2009/0125173 A1
(43) Pub. Date: May 14, 2009

(54) Hybrid vehicle with internal combustion engine and electric motor installed

(75) Inventors: Masayuki Komatsu, Aichi-gun (JP); Kaoru Kubo, Nishikamo-gun (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, Toyota-shi (JP)

(21) Appl. No.: 12/289,450

(22) Filed: Oct. 28, 2008

(30) Foreign Application Priority Data
Nov. 8, 2007 (JP) 2007-290799

(51) Int. Cl. B60W 20/00; G07C 5/00

(52) U.S. Cl. 701/22; 701/99; 180/65.265

(57) ABSTRACT

A display unit includes a speed display unit. The speed display unit includes an area, a threshold line and a pointer. The area indicates a vehicle speed (km/h). The threshold line indicates a threshold value at which operation and stop of an engine is switched. The threshold line is variably set by SOC and a temperature of a power storage device, a temperature of an inverter, a temperature of a motor generator and the like. The pointer indicates the movement direction of the threshold line.

This nonprovisional application is based on Japanese Patent Application No. 2007-290799 filed on Nov. 8, 2007 with the Japan Patent Office, the entire contents of which are hereby incorporated by reference.

### BACKGROUND OF THE INVENTION

1. Field of the Invention

This invention relates to a hybrid vehicle, particularly to a hybrid vehicle with an internal combustion engine and an electric motor installed as a power source for traveling.

2. Description of the Background Art

A hybrid vehicle draws attention as an eco-friendly automobile. In the hybrid vehicle, an electric motor driven by an inverter with using electric power stored in a power storage device is further installed as a power source in addition to a conventional engine.

When vehicle demand power is small, the engine is stopped and this hybrid vehicle travels only by the electric motor (electric motor traveling). When the vehicle demand power is increased, the engine is operated and the hybrid vehicle can travel by the electric motor and the engine (hybrid traveling).

Japanese Patent Laying-Open No. 2007-125921 discloses an accelerator pedal position indication bar for indicating a current accelerator pedal position and a range of accelerator pedal position at which the engine is operated in such a hybrid vehicle. A driver can adjust the accelerator pedal position so as not to operate the engine (so as to continue the electric motor traveling) by this accelerator pedal position indication bar.

However, the accelerator pedal position is not a parameter indicating an action itself of the vehicle but input means for reflecting an intention of the driver. Therefore, using the accelerator pedal position as a parameter for notifying the driver of timing at which the engine is operated/stopped is not always fit for a sense of the driver.

### SUMMARY OF THE INVENTION

Therefore, an object of this invention is to provide a hybrid vehicle capable of more properly notifying a driver of timing at which an internal combustion engine is operated/stopped.

According to this invention, the hybrid vehicle is a hybrid vehicle with an internal combustion engine and an electric motor installed as a power source for traveling including a control device and a display device. When a vehicle speed exceeds a first threshold value, the control device causes the internal combustion engine to operate. The display device displays the first threshold value together with the vehicle speed.

Preferably, the hybrid vehicle further includes a power storage device. The power storage device stores electric power to be supplied to the electric motor. As a state quantity indicating a state of charge of the power storage device (SOC) is lower, the control device sets the first threshold value to be lower.

Preferably, the hybrid vehicle further includes a power storage device. The power storage device stores electric power to be supplied to the electric motor. When a temperature of the power storage device is out of a specified range, the control device sets the first threshold value to a value lower than when the temperature is within the specified range.

Preferably, as a temperature of the electric motor is higher, the control device sets the first threshold value to be lower.

Preferably, the hybrid vehicle further includes a drive device. The drive device drives the electric motor. As a temperature of the drive device is higher, the control device sets the first threshold value to be lower.

Preferably, when the vehicle speed exceeds the first threshold value or when vehicle output exceeds a predetermined second threshold value, the control device causes the internal combustion engine to operate. The display device further displays the second threshold value together with the vehicle output.

Further preferably, the hybrid vehicle further includes a power storage device. The power storage device stores electric power to be supplied to the electric motor. As a state quantity indicating a state of charge of the power storage device (SOC) is lower, the control device sets the second threshold value to be lower.

Preferably, the hybrid vehicle further includes a power storage device. The power storage device stores electric power to be supplied to the electric motor. When a temperature of the power storage device is out of a specified range, the control device sets the second threshold value to a value lower than when the temperature is within the specified range.

Preferably, as a temperature of the electric motor is higher, the control device sets the second threshold value to be lower.

Preferably, the hybrid vehicle further includes a drive device. The drive device drives the electric motor. As a temperature of the drive device is higher, the control device sets the second threshold value to be lower.

Preferably, the display device displays the vehicle speed and the vehicle output in a two-dimensional area, and also displays an area at which the internal combustion engine is stopped in the two-dimensional area based on the first and second threshold values.

Further preferably, the display device further displays a contour line indicating that electric power consumption of the electric motor per unit traveling distance is substantially the same in the area at which the internal combustion engine is stopped.

In such a way, in this invention, when the vehicle speed or the vehicle output (vehicle power) exceeds a predetermined threshold value, the internal combustion engine is operated. Then, the display device displays the threshold value at which the internal combustion engine is operated together with the vehicle speed and/or the vehicle output. Therefore, a driver can adjust an operation amount of an accelerator pedal and a brake pedal so that the vehicle speed or the vehicle output does not exceed the threshold value, that is, the internal combustion engine is not operated based on the display of the display device.

Therefore, according to this invention, it is possible to properly notify the driver of timing at which the internal combustion engine is operated/stopped based on an action of the vehicle. Then, the driver is given an incentive for traveling the vehicle while stopping the internal combustion engine. As a result, it is possible to contribute to improvement in fuel consumption of the vehicle and reduction in CO₂ emission.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a function block diagram showing the entire configuration of a hybrid vehicle according to a first embodiment of this invention.

FIG. 2 is a view showing a display state of a display unit shown in FIG. 1.

FIG. 3 is a function block diagram of an ECU shown in FIG. 1.

FIG. 4 is a flowchart for illustrating a control structure of a traveling control unit shown in FIG. 3.

FIG. 5 is a view showing a display state of a display unit according to a second embodiment.

FIG. 6 is a flowchart for illustrating a control structure of a traveling control unit according to the second embodiment.

FIG. 7 is a view showing a display state of a display unit according to a third embodiment.

FIG. 8 is a view showing a display state in a case where a contour line is displayed on the display unit.

FIG. 9 is a function block diagram showing the entire configuration of a hybrid vehicle according to a fourth embodiment.

FIG. 10 is a view showing a zero-phase equivalent circuit of inverters and motor generators shown in FIG. 9.

FIG. 11 is a view showing a change in SOC of a power storage device at the time of traveling in the hybrid vehicle shown in FIG. 9.

### DESCRIPTION OF THE PREFERRED EMBODIMENTS

Hereinafter, embodiments of the present invention will be described in detail with reference to the drawings. It should be noted that the same parts or corresponding parts in the drawings are given the same reference numerals and a description of the parts will not be repeated.

### First Embodiment

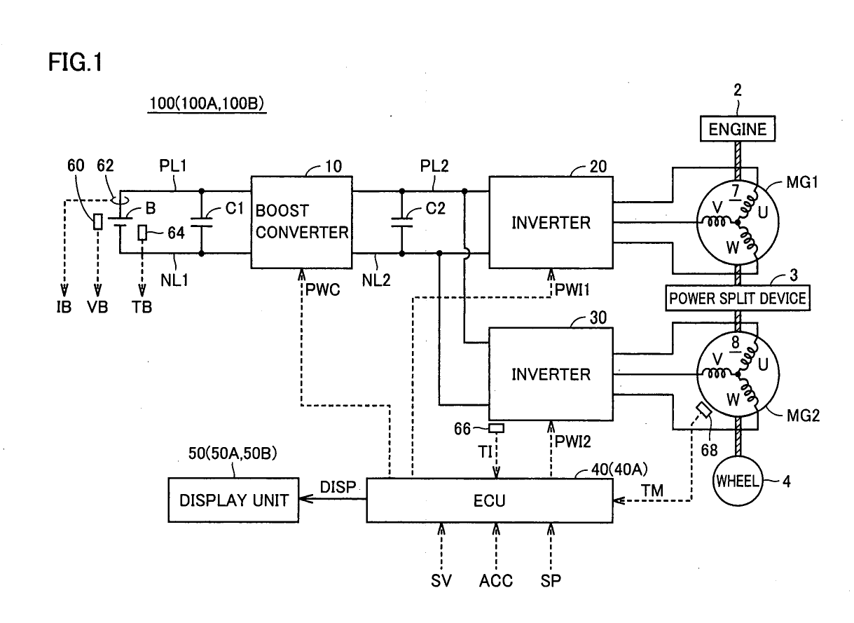

FIG. 1 is a function block diagram showing the entire configuration of a hybrid vehicle according to a first embodiment of this invention. With reference to FIG. 1, this hybrid vehicle 100 is provided with an engine 2, motor generators MG1 and MG2, a power split device 3, and a wheel 4. Hybrid vehicle 100 is further provided with a power storage device B, a boost converter 10, inverters 20 and 30, capacitors C1 and C2, an ECU (Electronic Control Unit) 40, and a display unit 50. Moreover, hybrid vehicle 100 is further provided with a voltage sensor 60, a current sensor 62, and temperature sensors 64, 66 and 68.

Engine 2 and motor generators MG1 and MG2 are linked to power split device 3. Then, hybrid vehicle 100 travels by drive force from motor generator MG2 and/or engine 2. Motive power generated by engine 2 is split into two routes by power split device 3. That is, one is the route to be transmitted to wheel 4, and the other is the route to be transmitted to motor generator MG1.

Motor generators MG1 and MG2 are a three-phase AC motor, for example formed by a three-phase AC synchronous motor. Motor generator MG1 generates the electric power with using the motive power of engine 2 split by power split device 3. For example, when SOC of power storage device B (a state quantity indicating a state of charge of power storage device B for example indicated by a value from 0% to 100% taking a full-charge state as 100%) is lower than a predetermined value, engine 2 is operated and motor generator MG1 generates the electric power. The generated electric power is supplied to power storage device B via inverter 20 and boost converter 10.

Motor generator MG2 generates the drive force with using at least one of the electric power stored in power storage device B and the electric power generated by motor generator MG1. Then, the drive force of motor generator MG2 is transmitted to wheel 4. At the time of braking the vehicle or the like, motor generator MG2 is driven by wheel 4 and motor generator MG2 is operated as an electric generator. Thereby, motor generator MG2 is operated as a regenerative brake for converting braking energy into the electric power. Then, the electric power generated by motor generator MG2 is supplied to power storage device B via inverter 30 and boost converter 10.

Power split device 3 is formed by a planetary gear including a sun gear, pinion gears, a carrier, and a ring gear. The pinion gears are engaged with the sun gear and the ring gear. The pinion gears are supported by the carrier so as to freely rotate. The carrier is linked to a crankshaft of engine 2. The sun gear is linked to a rotation shaft of motor generator MG1. The ring gear is linked to a rotation shaft of motor generator MG2.

Power storage device B is a DC power source capable of being charged, and for example formed by a nickel hydride secondary battery, a lithium ion secondary battery or the like. Power storage device B outputs DC power to boost converter 10. Power storage device B is charged by receiving the electric power output from boost converter 10. It should be noted that a capacitor having a large volume may be used as power storage device B.

Capacitor C1 smoothes a change in a voltage between a positive line PL1 and a negative line NL1. Boost converter 10 adjusts a voltage between a positive line PL2 and a negative line NL2 to be equal to or more than the voltage between positive line PL1 and negative line NL1, that is, equal to or more than a voltage of power storage device B based on a signal PWC from ECU 40. Boost converter 10 is for example formed by a known DC chopper circuit.

Capacitor C2 smoothes a change in the voltage between positive line PL2 and negative line NL2. Inverters 20 and 30 convert the DC power supplied from positive line PL2 and negative line NL2 into AC power and output the electric power to motor generators MG1 and MG2 respectively. Inverters 20 and 30 convert the AC power generated by motor generators MG1 and MG2 respectively into the DC power and output the electric power to positive line PL2 and negative line NL2 as regenerative electric power.

It should be noted that inverters 20 and 30 are for example respectively formed by a bridge circuit including switching elements for three phases. Then, inverters 20 and 30 perform a switching operation in accordance with signals PWI1 and PWI2 from ECU 40 respectively so as to drive the corresponding motor generators.

Voltage sensor 60 detects voltage VB of power storage device B and outputs the detected value to ECU 40. Current sensor 62 detects an electric current IB charged to and discharged from power storage device B and outputs the detected value to ECU 40. Temperature sensor 64 detects a temperature TB of power storage device B and outputs the detected value to ECU 40. Temperature sensor 66 detects a temperature TI of inverter 30 and outputs the detected value to ECU 40. Temperature sensor 68 detects a temperature TM of motor generator MG2 and outputs the detected value to ECU 40.

ECU 40 generates signal PWC for driving boost converter 10 and signals PWI1 and PWI2 for driving motor generator MG1 and MG2 respectively and outputs generated signals PWC, PWI1 and PWI2 to boost converter 10 and inverters 20 and 30 respectively.

ECU 40 controls switching between traveling with stopping engine 2 and using only motor generator MG2 (hereinafter, also called as the “EV traveling”) and traveling with operating engine 2 (hereinafter, also called as the “HV traveling”) based on a vehicle speed signal SV indicating the vehicle speed. Specifically, ECU 40 sets an engine non-operation vehicle speed threshold value indicating the vehicle speed at which operation and stop of engine 2 is switched based on the detected values from the sensors and compares the vehicle speed indicated by the vehicle speed signal SV with the set engine non-operation vehicle speed threshold value so as to control the switching between the operation and the stop of engine 2.

ECU 40 outputs the set engine non-operation vehicle speed threshold value and a change amount of the threshold value from the time of the preceding mathematical operation (or from the moment before a predetermined time) together with vehicle speed signal SV to display unit 50 as display data DISP. It should be noted that a configuration of ECU 40 will be described later in detail.

Display unit 50 displays the vehicle speed based on vehicle speed signal SV received from ECU 40 and displays the vehicle speed threshold value for switching between the operation and the stop of engine 2 while indicating the movement direction thereof as described later based on the engine non-operation vehicle speed threshold value and the change amount of the threshold value included in display data DISP.

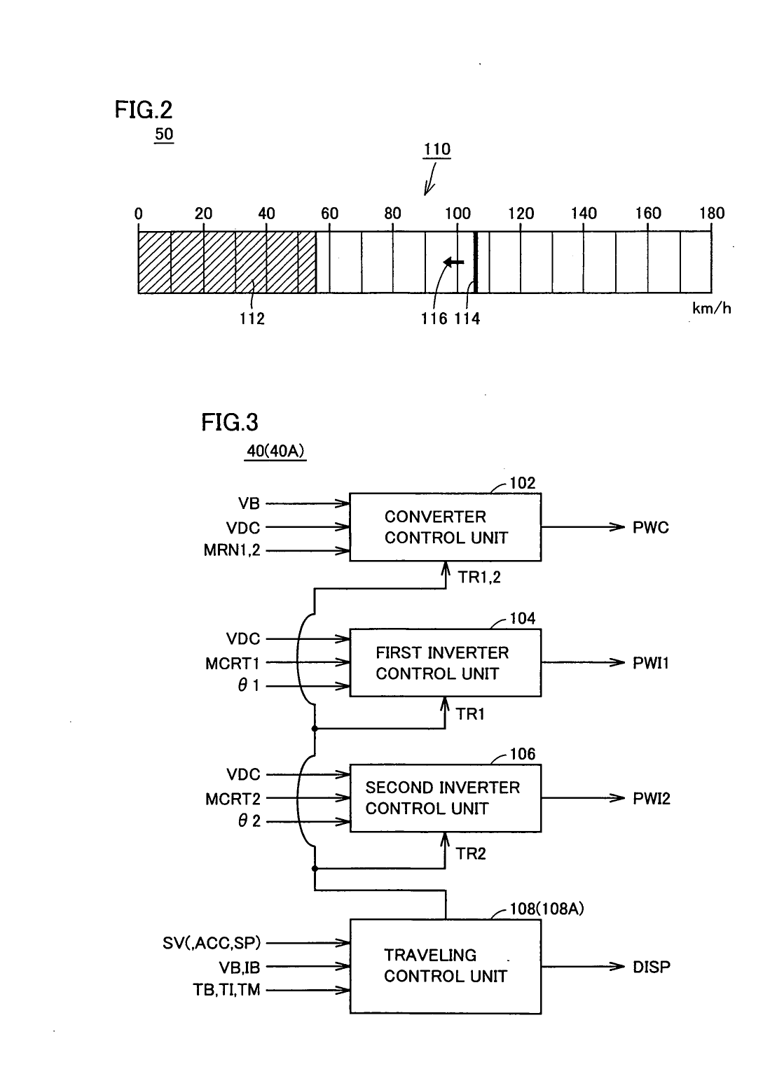

FIG. 2 is a view showing a display state of display unit 50 shown in FIG. 1. With reference to FIG. 2, display unit 50 includes a speed display unit 110. Speed display unit 110 includes an area 112, a threshold line 114 and a pointer 116.

Area 112 indicates the vehicle speed (km/h) based on vehicle speed signal SV received from ECU 40. Threshold line 114 indicates the vehicle speed threshold value at which operation and stop of engine 2 is switched based on the engine non-operation vehicle speed threshold value received from ECU 40. That is, when the vehicle speed indicated by area 112 is lower than threshold line 114, engine 2 is stopped. When the vehicle speed indicated by area 112 exceeds threshold line 114, engine 2 is operated.

Pointer 116 indicates the movement direction of threshold line 114 based on the change amount of the engine non-operation vehicle speed threshold value received from ECU 40. This pointer 116 gives a driver a tendency of a change in the engine non-operation vehicle speed threshold value. In a case where the vehicle speed comes closer to the threshold value by a decrease in the engine non-operation vehicle speed threshold value even with a constant vehicle speed, pointer 116 calls upon the driver to decelerate and maintain the EV traveling.

FIG. 3 is a function block diagram of ECU 40 shown in FIG. 1. With reference to FIG. 3, ECU 40 includes a converter control unit 102, a first inverter control unit 104, a second inverter control unit 106 and a traveling control unit 108.

Converter control unit 102 generates signal PWC for driving boost converter 10 based on voltage VB of power storage device B, voltage VDC between positive line PL2 and negative line NL2, rotation speeds MRN1 and MRN2 of motor generators MG1 and MG2 and torque command values TR1 and TR2 of motor generators MG1 and MG2 received from traveling control unit 108, and outputs generated signal PWC to boost converter 10. It should be noted that voltage VDC and rotation speed MRN1 and MRN2 are detected by a sensor (not shown).

First inverter control unit 104 generates signal PWI1 for driving motor generator MG1 based on voltage VDC, a motor current MCRT1 and a rotor rotation angle θ1 of motor generator MG1 and torque command value TRI. Second inverter control unit 106 generates signal PWI2 for driving motor generator MG2 based on voltage VDC, a motor current MCRT2 and a rotor rotation angle θ2 of motor generator MG2 and torque command value TR2. It should be noted that motor currents MCRT1 and MCRT2 and rotor rotation angles θ1 and θ2 are detected by a sensor (not shown).

Traveling control unit 108 receives vehicle speed signal SV, and detected values of voltage VB, electric current IB and temperature TB of power storage device B, temperature TI of inverter 30 and temperature TM of motor generator MG2. Then, traveling control unit 108 determines whether or not to travel with operating engine 2 by a method described later, generates torque command values TR1 and TR2 based on a result of the determination, and outputs torque command values TR1 and TR2 to converter control unit 102 and first and second inverter control units 104 and 106.

Traveling control unit 108 outputs vehicle speed signal SV, the engine non-operation vehicle speed threshold value set based on the detected values of the sensors, and the change amount of the threshold value from the time of preceding mathematical operation (or from the moment before a predetermined time) to display unit 50 as display data DISP.

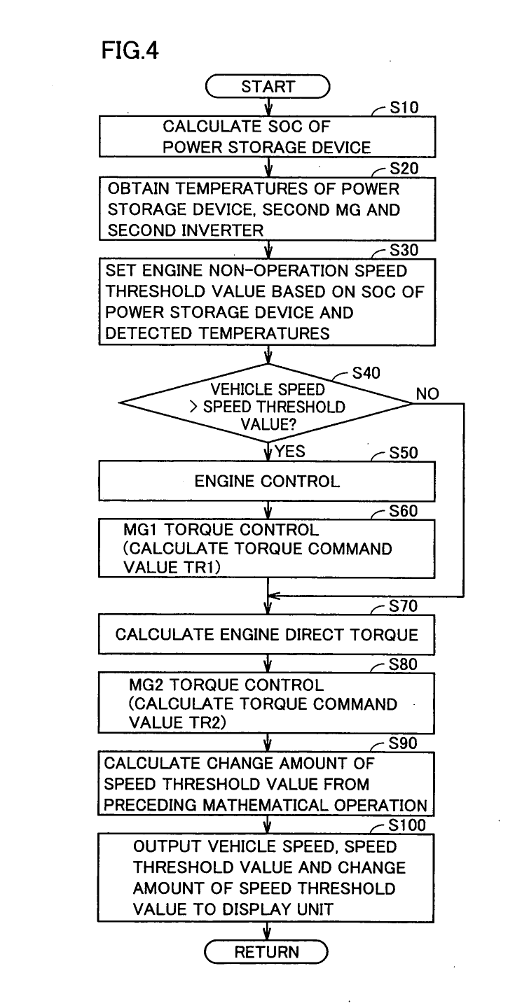

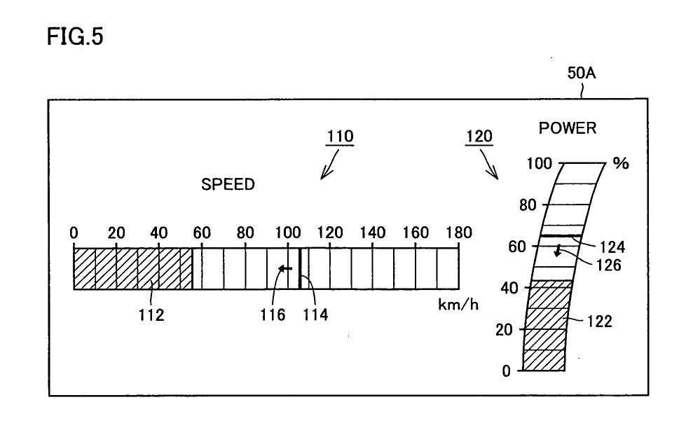

FIG. 4 is a flowchart for illustrating a control structure of traveling control unit 108 shown in FIG. 3. It should be noted that processing of this flowchart is invoked from a main routine and executed at a fixed time interval or every time when a predetermined condition is met during running of a vehicle system.

With reference to FIG. 4, traveling control unit 108 calculates the SOC of power storage device B based on voltage VB and electric current IB of power storage device B (Step S10). It should be noted that various known methods can be used as a calculation method of the SOC.

Next, traveling control unit 108 obtains the detected value of temperature TB of power storage device B from temperature sensor 64, obtains the detected value of temperature TI of inverter 30 from temperature sensor 66, and obtains the detected value of temperature TM of motor generator MG2 from temperature sensor 68 (Step S20).

Then, traveling control unit 108 sets the engine non-operation vehicle speed threshold value for determining whether engine 2 is operated or stopped based on the SOC of power storage device B and the detected temperatures of power storage device B, inverter 30 and motor generator MG2 (Step S30). Specifically, a charging and discharging characteristic of power storage device B is decreased in a low temperature area and a high temperature area. Therefore, when temperature TB of power storage device B is out of a specified range, traveling control unit 108 sets the engine non-operation vehicle speed threshold value to a value lower than when the temperature is within the specified range. In a case where at least one of inverter 30 and motor generator MG2 is at a high temperature, there is a need for suppressing a load of motor generator MG2 assisted by the drive force by engine 2. Therefore, as the temperature of inverter 30 or motor generator MG2 is higher, traveling control unit 108 sets the engine non-operation vehicle speed threshold value to be lower.

Next, traveling control unit 108 determines whether or not current vehicle speed indicated by vehicle speed signal SV is larger than the engine non-operation vehicle speed threshold value set in Step S30 (Step S40). When it is determined that the current vehicle speed is equal to or less than the engine non-operation vehicle speed threshold value (NO in Step S40), the processing is moved to Step S70 described later. Meanwhile, when it is determined that the current vehicle speed is larger than the engine non-operation vehicle speed threshold value in Step S40 (YES in Step S40), traveling control unit 108 calculates target rotation speed of engine 2 and actually executes control of engine 2 (Step S50). Then, traveling control unit 108 calculates target rotation speed of motor generator MG1 for maintaining engine 2 at the target rotation speed, and calculates torque command value TR1 for controlling motor generator MG1 at the target rotation speed (Step S60).

Next, traveling control unit 108 calculates generated torque of engine 2 (engine direct torque) from torque command value TR1 of motor generator MG1 (Step S70). It should be noted that the engine direct torque can be calculated from torque command value TR1 based on a geometric configuration (gear ratio) of power split device 3. It should be noted that when the vehicle speed is equal to or less than the engine non-operation vehicle speed threshold value, engine 2 is stopped. Therefore, the engine direct torque is zero. Then, when the engine direct torque is calculated, traveling control unit 108 subtracts the engine direct torque from drive demand torque of the vehicle so as to calculate torque command value TR2 of motor generator MG2 (Step S80).

Next, traveling control unit 108 calculates the change amount of the engine non-operation vehicle speed threshold value from the time of the preceding mathematical operation (Step S90). This change amount indicates the tendency of the change in the engine non-operation vehicle speed threshold value, and may be a change amount from the moment before a predetermined time instead of the change amount from the time of preceding mathematical operation. Then, traveling control unit 108 outputs vehicle speed signal SV, the engine non-operation vehicle speed threshold value and the change amount of the engine non-operation vehicle speed threshold value to display unit 50 as display data DISP (Step S100).

As mentioned above, in this first embodiment, when the vehicle speed exceeds the engine non-operation vehicle speed threshold value, engine 2 is operated. Display unit 50 displays the engine non-operation vehicle speed threshold value together with the vehicle speed. Therefore, the driver can adjust an operation amount of an accelerator pedal and a brake pedal so that the vehicle speed does not exceed the engine non-operation vehicle speed threshold value, that is, engine 2 is not operated based on the display of display unit 50. Consequently, according to this first embodiment, it is possible to properly notify the driver of timing for operating/stopping engine 2 based on an action of the vehicle.

In this first embodiment, the engine non-operation vehicle speed threshold value is set based on the SOC of power storage device B and temperature TB of power storage device B, temperature TI of inverter 30, temperature TM of motor generator MG2 and the like, and the change is displayed on display unit 50. Therefore, according to this first embodiment, it is possible to properly notify the driver of timing for operating/stopping engine 2 in accordance with a state change of the vehicle.

Further, in this first embodiment, the tendency of the change in the engine non-operation vehicle speed threshold value is displayed on display unit 50 by pointer 116. Therefore, according to this first embodiment, in the case where the vehicle speed comes closer to the threshold value by the decrease in the engine non-operation vehicle speed threshold value even with the constant vehicle speed, it is possible to call upon the driver to decelerate and maintain the EV traveling.

### Second Embodiment

In this second embodiment, the switching between traveling only with motor generator MG2 while stopping engine 2 (EV traveling) and traveling with operating engine 2 (HV traveling) is controlled based on the vehicle speed and vehicle power. Then, a display unit displays the vehicle speed and the engine non-operation vehicle speed threshold value and further displays the vehicle power and an engine non-operation power threshold value corresponding to the vehicle power.

With reference to FIG. 1 again, a hybrid vehicle 100A according to this second embodiment is provided with an ECU 40A and a display unit 50A instead of ECU 40 and display unit 50 respectively in the configuration of hybrid vehicle 100 according to the first embodiment shown in FIG. 1.

ECU 40A calculates vehicle demand power, and controls the switching between traveling only with motor generator MG2 while stopping engine 2 (EV traveling) and traveling with operating engine 2 (HV traveling) based on the calculated vehicle demand power and vehicle speed signal SV. Specifically, ECU 40A sets the engine non-operation vehicle speed threshold value and the engine non-operation power threshold value indicating the vehicle power at which operation and stop of engine 2 is switched based on the detected values from the sensors. Then, ECU 40A compares the vehicle speed with the engine non-operation vehicle speed threshold value and compares the vehicle demand power with the engine non-operation power threshold value so as to control the switching between the operation and the stop of engine 2.

ECU 40A outputs vehicle speed signal SV, the engine non-operation vehicle speed threshold value, the change amount of the vehicle speed threshold value from the time of the preceding mathematical operation (or from the moment before a predetermined time), the vehicle demand power, the engine non-operation power threshold value, a change amount of the power threshold value from the time of the preceding mathematical operation (or from the moment before a predetermined time) to display unit 50A as display data DISP. It should be noted that a configuration of ECU 40A will be described later in detail.

As well as display unit 50, display unit 50A displays the vehicle speed and displays the engine non-operation vehicle speed threshold value while indicating the movement direction thereof Further, display unit 50A displays the vehicle power based on the vehicle demand power received from ECU 40A and displays the power threshold value at which operation and stop of engine 2 is switched while indicating the movement direction thereof based on the engine non-operation power threshold value and the change amount of the threshold value included in display data DISP.

FIG. 5 is a view showing a display state of display unit 50A in the second embodiment. With reference to FIG. 5, display unit 50A includes speed display unit 110 and a power display unit 120. Speed display unit 110 and power display unit 120 are arranged adjacently to each other so that the driver can visually recognize at the same time.

Power display unit 120 includes an area 122, a threshold line 124 and a pointer 126. Area 122 indicates the vehicle power (%) based on the vehicle demand power received from ECU 40A. It should be noted that this vehicle power (%) is indicated by a value from 0% to 100% taking maximum power of the vehicle as 100%. However, the vehicle power (%) may be an absolute value of the vehicle power.

Threshold line 124 indicates the vehicle power threshold value (%) at which operation and stop of engine 2 is switched based on the engine non-operation power threshold value received from ECU 40A. That is, when the vehicle power indicated by area 122 is smaller than threshold line 124, engine 2 is stopped. When the vehicle power indicated by area 122 exceeds threshold line 124, engine 2 is operated.

Pointer 126 indicates the movement direction of threshold line 124 based on the change amount of the engine non-operation power threshold value received from ECU 40A. This pointer 126 gives the driver a tendency of a change in the engine non-operation power threshold value. In a case where the vehicle power comes closer to the threshold value by a decrease in the engine non-operation power threshold value even with constant vehicle power, pointer 126 calls upon the driver to decelerate and maintain the EV traveling.

With reference to FIG. 3 again, ECU 40A in this second embodiment includes a traveling control unit 108A instead of traveling control unit 108 in the configuration of ECU 40 in the first embodiment shown in FIG. 3.

Traveling control unit 108A receives vehicle speed signal SV, an accelerator pedal position signal ACC indicating the operation amount of the accelerator pedal, a shift position signal SP indicating a shift position, and the detected values of voltage VB, electric current IB and temperature TB of power storage device B, temperature TI of inverter 30 and temperature TM of motor generator MG2. Then, traveling control unit 108A determines whether or not to travel with operating engine 2 by a method described later, generates torque command values TR1 and TR2 based on a result of the determination, and outputs torque command values TR1 and TR2 to converter control unit 102 and first and second inverter control units 104 and 106.

Traveling control unit 108A also outputs vehicle speed signal SV, the vehicle demand power, the engine non-operation vehicle speed threshold value and the engine non-operation power threshold value both set based on the detected values of the sensors, and the change amounts of the threshold values from the time of preceding mathematical operation (or from the moment before a predetermined time) to display unit 50A as display data DISP.

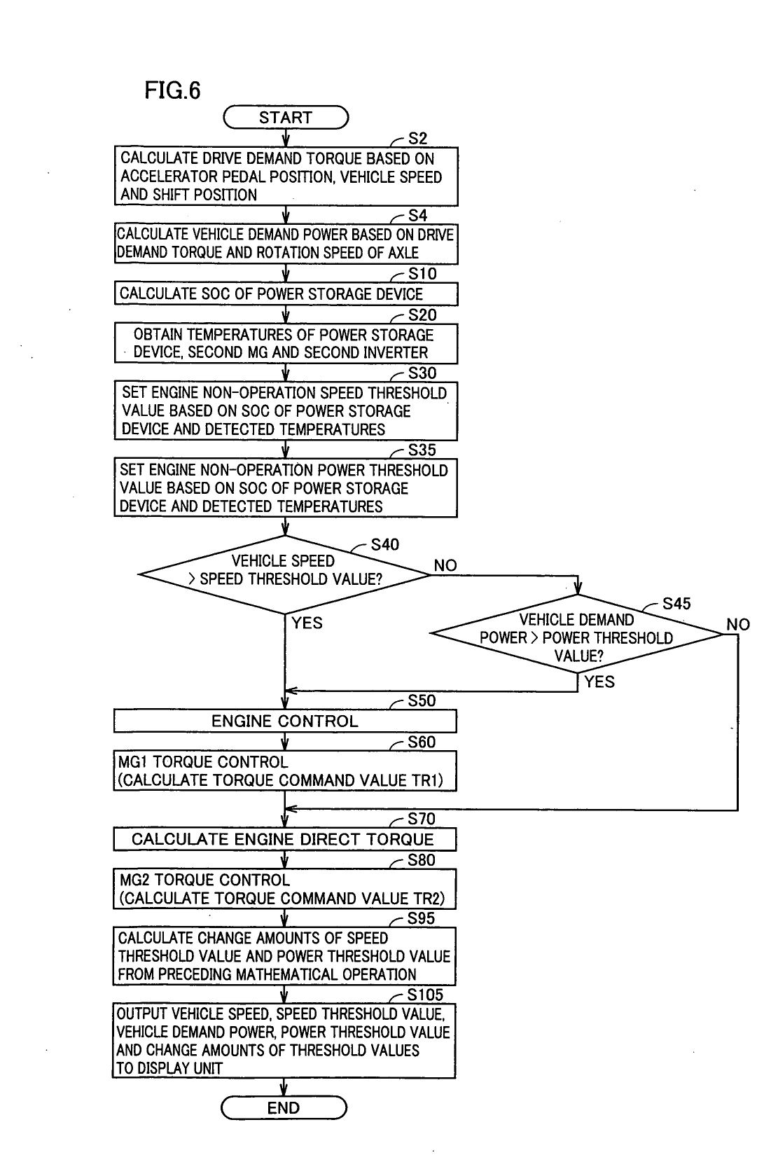

FIG. 6 is a flowchart for illustrating a control structure of traveling control unit 108A in the second embodiment. It should be noted that processing of this flowchart is also invoked from the main routine and executed at a fixed time interval or every time when a predetermined condition is met during running of the vehicle system.

With reference to FIG. 6, this flowchart further includes Steps S2, S4, S35 and S45 and includes Steps S95 and S105 instead of Steps S90 and S100 in the flowchart shown in FIG. 4.

That is, traveling control unit 108A calculates the drive demand torque of the vehicle with using a map, a mathematical operation preliminarily set or the like based on the accelerator pedal position and the vehicle speed and the shift position indicated by accelerator pedal position signal ACC, vehicle speed signal SV and shift position signal SP respectively previous to the processing in Step S10 (Step S2). Then, traveling control unit 108A calculates the vehicle demand power based on the calculated drive demand torque and rotation speed of axle (Step S4). Specifically, the vehicle demand power is calculated by multiplying the drive demand torque by the rotation speed. Then, the processing is moved to Step S10 in traveling control unit 108A.

When the engine non-operation speed threshold value is set in Step S30, traveling control unit 108A sets the engine non-operation power threshold value for determining whether to operate or stop engine 2 based on the SOC of power storage device B and the detected temperatures of power storage device B, inverter 30 and motor generator MG2 (Step S35). Specifically, as well as the engine non-operation speed threshold value, when temperature TB of power storage device B is out of the specified range, traveling control unit 108A sets the engine non-operation power threshold value to a value lower than when the temperature is within the specified range. As the temperature of inverter 30 or motor generator MG2 is higher, traveling control unit 108A sets the engine non-operation power threshold value to be lower.

When it is determined that the current vehicle speed is equal to or less than the engine non-operation vehicle speed threshold value in Step S40 (NO in Step S40), traveling control unit 108A determines whether or not the vehicle demand power calculated in Step S4 is larger than the engine non-operation power threshold value set in Step S35 (Step S45).

When it is determined that current vehicle demand power is larger than the engine non-operation power threshold value (YES in Step S45), the processing is moved to Step S50 in traveling control unit 108A. Meanwhile, when it is determined that the current vehicle demand power is equal to or less than the engine non-operation power threshold value (NO in Steps S45), the processing is moved to Step S70 in traveling control unit 108A.

When torque command value TR2 is calculated in Step S80, traveling control unit 108A calculates the change amount of the engine non-operation vehicle speed threshold value from the time of the preceding mathematical calculation and calculates the change amount of the engine non-operation power threshold value from the time of the preceding mathematical calculation (Step S95). This change amount of the engine non-operation power threshold value indicates the tendency of the change in the engine non-operation power threshold value, and may be a change amount from the moment before a predetermined time instead of the change amount from the time of preceding mathematical operation.

Then, traveling control unit 108A outputs vehicle speed signal SV, the engine non-operation vehicle speed threshold value, the vehicle demand power, the engine non-operation power threshold value as well as the change amounts of the engine non-operation vehicle speed threshold value and the engine non-operation power threshold value calculated in Step S95 to display unit 50A as display data DISP (Step S105).

As mentioned above, in this second embodiment, when the vehicle speed or the vehicle power exceeds the engine non-operation threshold value, engine 2 is operated. Display unit 50A displays the engine non-operation vehicle speed threshold value together with the vehicle speed, and further displays the engine non-operation power threshold value together with the vehicle power. Therefore, the driver can adjust the operation amount of the accelerator pedal and the brake pedal so that the vehicle speed and the vehicle power do not exceed the engine non-operation threshold values, that is, engine 2 is not operated based on the display of display unit 50A. Consequently, according to this second embodiment, it is possible to properly notify the driver of the timing at which engine 2 is operated/stopped based on actions of the vehicle.

In this second embodiment, the engine non-operation power threshold value is set based on the SOC and temperature TB of power storage device B, temperature TI of inverter 30, temperature TM of motor generator MG2 and the like, and the change is displayed on display unit 50A. Further, pointer 126 indicates the tendency of the change in the engine non-operation power threshold value on display unit 50A. Therefore, according to this second embodiment, it is possible to obtain the same effect as the first embodiment.

### Third Embodiment

In the second embodiment, the vehicle speed and the vehicle power are displayed on separate meters. However, in this third embodiment, the vehicle speed and the vehicle power are two-dimensionally displayed on one meter.

A hybrid vehicle 100B according to this third embodiment is provided with a display unit 50B instead of display unit 50A in the configuration of hybrid vehicle 100A according to the second embodiment. Display unit 50B two-dimensionally displays the vehicle speed and the vehicle power and displays the engine non-operation threshold values while indicating the movement direction thereof based on the engine non-operation vehicle speed threshold value, the engine non-operation power threshold value and the change amounts of the threshold values received from ECU 40A.

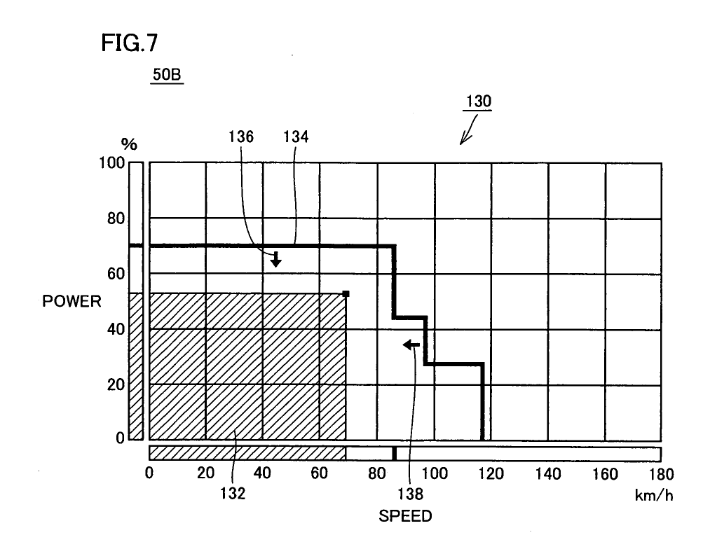

FIG. 7 is a view showing a display state of display unit 50B in the third embodiment. With reference to FIG. 7, display unit 50B includes a speed/power display unit 130. Speed/power display unit 130 displays the vehicle speed (km/h) at the horizontal axis, and displays the vehicle power (%) at the vertical axis.

Speed/power display unit 130 includes an area 132, a threshold line 134 and pointers 136 and 138. Area 132 indicates the current vehicle speed in the horizontal axis direction and the current vehicle power (%) in the vertical axis direction based on vehicle speed signal SV and the vehicle demand power received from ECU 40A. Threshold line 134 indicates the threshold value at which operation and stop of engine 2 is switched based on the engine non-operation vehicle speed threshold value and the engine non-operation power threshold value received from ECU 40A. That is, when the vehicle speed and the vehicle power indicated by area 132 are within an area surrounded by threshold line 134, engine 2 is stopped. When the vehicle speed and the vehicle power indicated by area 132 exceed threshold line 134, engine 2 is operated.

This threshold line 134 is set based on the engine non-operation vehicle speed threshold value and the engine non-operation power threshold value. It should be noted that as the speed is higher, the power capable of being further output by motor generator MG2 is more limited. Therefore, as the speed is higher, the engine non-operation threshold value relative to power is suppressed more (that is, as the speed is higher, engine 2 is started by less acceleration demand). Consequently, when the speed is a certain degree or higher, engine 2 is always operated.

Pointer 136 indicates the movement direction of threshold line 134 in the vertical axis direction based on the change amount of the engine non-operation power threshold value received from ECU 40A. Pointer 138 indicates the movement direction of threshold line 134 in the horizontal axis direction based on the change amount of the engine non-operation vehicle speed threshold value received from ECU 40A. These pointers 136 and 138 give the driver a tendency of the change in the engine non-operation threshold values. In a case where a current traveling state comes closer to the threshold values by the change in the engine non-operation threshold values even with a constant traveling state, pointers 136 and 138 call upon the driver to decelerate and maintain the EV traveling.

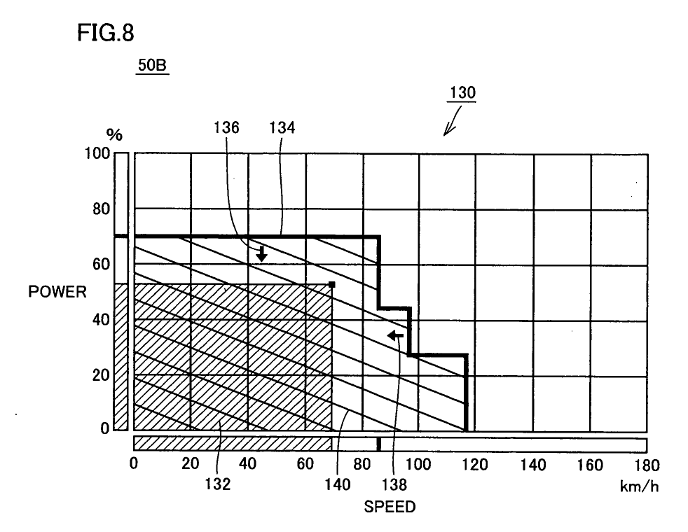

It should be noted that as shown in FIG. 8, a contour line 140 indicating that electric power consumption of motor generator MG2 per unit traveling distance is substantially the same may be displayed in the area surrounded by threshold line 134 (the area for stopping engine 2). Thereby, even during the EV traveling, it is possible to give the driver an incentive for traveling the vehicle with lower electric power consumption.

As mentioned above, in this third embodiment, display unit 50B two-dimensionally displays the vehicle speed and the vehicle power, and further displays the engine non-operation threshold values while indicating the movement direction thereof. Therefore, according to this third embodiment, a relationship between the current traveling state (the vehicle speed and the vehicle power) and the threshold values at which operation and stop of the engine is switched is quite obvious. It is possible to contribute to instantaneous judgment of the driver and execution of a proper driving operation.

By displaying contour line 140 within the area surrounded by threshold line 134, it is possible to give the driver the incentive for traveling the vehicle with lower electric power consumption.

According to this third embodiment, the vehicle speed and a generation state of the vehicle power can be recognized at the same time. Therefore, it is possible to create pleasure at driving.

### Fourth Embodiment

This fourth embodiment shows a case where the present invention is applied to a so-called “plug-in hybrid vehicle” capable of charging a power storage device installed in a vehicle from an external power source. The plug-in hybrid vehicle is a hybrid vehicle capable of performing the EV traveling of long distance with using the electric power supplied from the external power source, and required to properly notify the driver of the timing for operating/stopping engine 2. That is, this invention is preferable for such a plug-in hybrid vehicle.

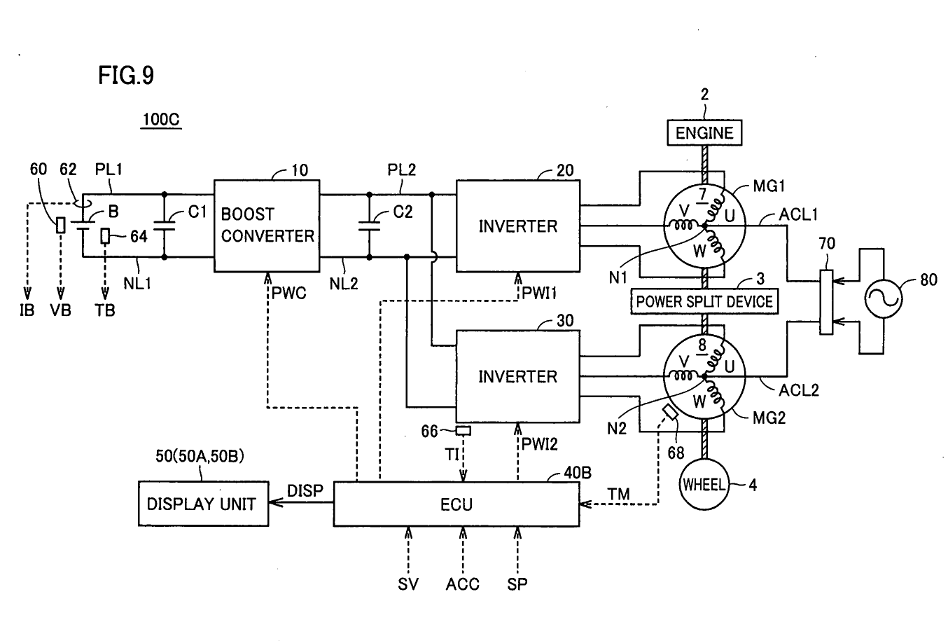

FIG. 9 is a function block diagram showing the entire configuration of a hybrid vehicle according to the fourth embodiment. With reference to FIG. 9, a hybrid vehicle 100C is further provided with a power receiving unit 70 and power input lines ACL1 and ACL2 and provided with an ECU 40B instead of ECU 40 (or 40A) in the configuration of hybrid vehicle according to any of the first to third embodiments.

Motor generator MG1 includes a Y-connected three-phase coil 7 as a stator coil. A neutral point N1 of three-phase coil 7 is connected to power input line ACL1. Motor generator MG2 also includes a Y-connected three-phase coil 8 as the stator coil. A neutral point N2 of three-phase coil 8 is connected to power input line ACL2. Then, power input lines ACL1 and ACL2 are connected to power receiving unit 70. Power receiving unit 70 is an electric power interface for receiving the electric power for charging power storage device B from an external power source 80.

When power storage device B is charged from power source 80, ECU 40B generates signals PWI1 and PWI2 for controlling inverters 20 and 30 so that AC power given from power source 80 to neutral points N1 and N2 via power input lines ACL1 and ACL2 is converted into DC power and output to positive line PL2.

It should be noted that the other configurations of ECU 40B are the same as ECU 40 (or 40A). The other configurations of hybrid vehicle 100C are the same as hybrid vehicle 100 (or 100A or 100B) shown in the first to third embodiments.

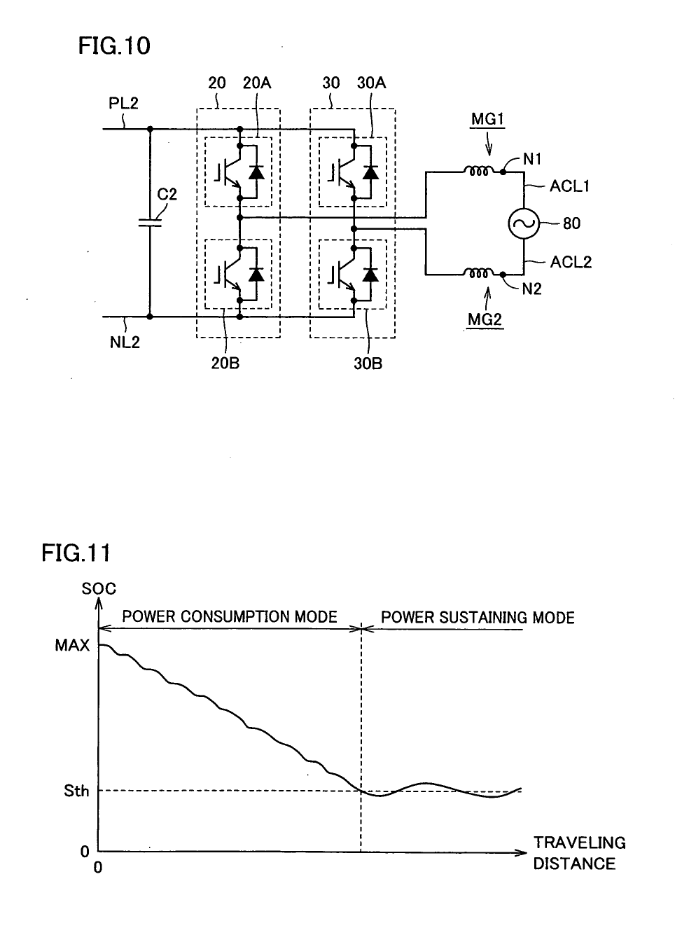

FIG. 10 is a view showing a zero-phase equivalent circuit of inverters 20 and 30 and motor generators MG1 and MG2 shown in FIG. 9. In each of inverters 20 and 30 formed by the three-phase bridge circuit, there are eight patterns of an ON/OFF combination for six transistors. Two of the eight switching patterns have an interphase voltage of zero. Such a voltage state is called as a zero voltage vector. With regard to the zero voltage vector, three transistors of an upper arm can be regarded as the same switching state (all ON or OFF), and three transistors of a lower arm can be regarded as the same switching state as each other. Therefore, in this FIG. 10, the three transistors of the upper arm of inverter 20 are collectively shown as an upper arm 20A, and the three transistors of the lower arm of inverter 20 are collectively shown as a lower arm 20B. Similarly, the three transistors of the upper arm of inverter 30 are collectively shown as an upper arm 30A, and the three transistors of the lower arm of inverter 30 are collectively shown as a lower arm 30B.

As shown in FIG. 10, this zero-phase equivalent circuit can be seen as a single-phase PWM converter taking single phase AC power given to neutral points N1 and N2 via power input lines ACL1 and ACL2 as an input. Then, the zero voltage vector is changed in inverters 20 and 30 and switching control is performed so as to operate inverters 20 and 30 as arms of the single-phase PWM converter. Thereby, it is possible to convert the AC power input from power input lines ACL1 and AC2 into the DC power and output the electric power to positive line PL2.

FIG. 11 is a view showing a change in the SOC of power storage device B at the time of traveling in hybrid vehicle 100C shown in FIG. 9. With reference to FIG. 11, provided that power storage device B is charged from external power source 80 and the traveling of hybrid vehicle 100C is started from a full charge (MAX) state of power storage device B. The SOC is not sustained until the SOC of power storage device B comes below a predetermined threshold value Sth. Hybrid vehicle 100C travels in “power consumption mode” for proactively consuming the electric power stored in power storage device B from power source 80.

Then, when the SOC of power storage device B comes below threshold value Sth, hybrid vehicle 100C operates engine 2, generates the electric power by motor generator MG1, and travels in “power sustaining mode” for sustaining the SOC of power storage device B in the vicinity of threshold value Sth.

In hybrid vehicle 100C according to this fourth embodiment, by providing display unit 50 (or 50A or 50B), it is possible to suppress the operation of engine 2 in the power consumption mode aspired in the plug-in hybrid vehicle originally. That is, even in the power consumption mode, when the vehicle speed or the vehicle power exceeds the engine non-operation threshold value, engine 2 is operated. However, in this hybrid vehicle 100C, display unit 50 (or 50A or 50B) displays the engine non-operation threshold values together with the vehicle speed and/or the vehicle power. Therefore, it is possible to give the driver the incentive for the EV traveling of traveling the vehicle while stopping engine 2.

In such a way, in this fourth embodiment, it is possible to charge power storage device B from external power source 80. A user of such a plug-in hybrid vehicle is highly aware of environment and cost and aspires the EV traveling with operating engine 2 as less as possible. Therefore, in this fourth embodiment, foregoing display unit 50 (or 50A or 50B) is provided so as to properly notify the driver of the timing for operating/stopping engine 2. Consequently, according to this fourth embodiment, it is possible to produce the greatest effect of the plug-in hybrid vehicle aspired for the EV traveling of long distance.

It should be noted that in the fourth embodiment, power storage device B is charged by giving neutral points N1 and N2 the AC power from power source 80 and operating inverters 20 and 30 and motor generators MG1 and MG2 as the single-phase PWM converter. However, a voltage converter and a rectifier exclusive for charging power storage device B from power source 80 may be separately provided.

It should be noted that in the above embodiments, in the case where the vehicle speed or the vehicle power exceeds the engine non-operation threshold value, the engine non-operation threshold value may be set to be a smaller value relative to the time when the vehicle speed or the vehicle power is smaller than the engine non-operation threshold value. Thereby, when the vehicle speed or the vehicle power is in the vicinity of the engine non-operation threshold value, it is possible to prevent frequent repeat of operating/stopping engine 2.

In the above embodiments, in a case where the vehicle speed or the vehicle power exceeds the engine non-operation threshold value and engine 2 is operated, display color for the entire areas 112, 122 and 132 or a part of areas 112, 122 and 132 exceeding the threshold values may be changed.

In the above embodiments, in a case where engine 2 is operated by a decrease in the SOC of power storage device B irrespective of the vehicle speed or the vehicle power (including the power sustaining mode in the fourth embodiment), the engine non-operation threshold value may be set to be a lower limit value, or threshold lines 114, 124 and 134 may be not displayed. Thereby, it is possible to notify the driver of the case where engine 2 is operated by the decrease in the SOC of power storage device B by differentiating a case from a case where engine 2 is operated by the fact that the vehicle speed or the vehicle power exceeds the engine non-operation threshold value.

In the above embodiments, in the case where the vehicle speed or the vehicle power exceeds the engine non-operation threshold value by the decrease in the engine non-operation threshold value even with no change in the vehicle speed or the vehicle power, start of engine 2 may be inhibited for a predetermined time (at least for the time enabling the driver to correspond such as to decelerate the vehicle). Thereby, it is possible to prevent that engine 2 is started without any condition by the state change of the vehicle and to maintain the EV traveling by enabling the driver to correspond such as to decelerate.

In the above embodiments, when the driver operates the accelerator pedal or the brake pedal, the change in the engine non-operation threshold values may be inhibited. In other words, the change in the engine non-operation threshold values may be permitted when the driver does not operate the accelerator pedal or the brake pedal. Thereby, the driver easily maintains the EV traveling even in the vicinity of the engine non-operation threshold values.

In the above embodiments, when the vehicle speed or the vehicle power is changed, the change in the engine non-operation threshold value may be inhibited. In other words, the change in the engine non-operation threshold value may be permitted when the vehicle speed or the vehicle power is not changed. Thereby, the driver also easily maintains the EV traveling in the vicinity of the engine non-operation threshold values.

It should be noted that in the above embodiments, the series-parallel hybrid vehicle capable of splitting the mechanical power of engine 2 by power split device 3 and transmitting the mechanical power to wheel 4 and motor generator MG1 is described. However, this invention can also be applied to other hybrid vehicles. That is, for example, this invention can also be applied to a so-called series hybrid vehicle of using engine 2 only for driving motor generator MG1 and generating the drive force of the vehicle only by motor generator MG2, a hybrid vehicle of collecting only regenerative energy among motion energy generated by engine 2 as electric energy, a motor-assisting hybrid vehicle taking the engine as major mechanical power with assistance of a motor according to need, and the like.

This invention can also be applied to a hybrid vehicle not provided with boost converter 10.

It should be noted that in the above, engine 2 corresponds to an “internal combustion engine” in this invention, and motor generator MG2 corresponds to an “electric motor” in this invention. ECUs 40, 40A and 40B correspond to a “control device” in this invention, and display units 50, 50A and 50B correspond to a “display device” in this invention.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A hybrid vehicle with an internal combustion engine and an electric motor installed as a power source for traveling, comprising:
a control device causing said internal combustion engine to operate when a vehicle speed exceeds a predetermined first threshold value; and
a display device displaying said first threshold value together with said vehicle speed.

2. The hybrid vehicle according to claim 1, further comprising:
a power storage device storing electric power to be supplied to said electric motor, wherein
as a state quantity indicating a state of charge of said power storage device is lower, said control device sets said first threshold value to be lower.

3. The hybrid vehicle according to claim 1, further comprising:
a power storage device storing electric power to be supplied to said electric motor, wherein
when a temperature of said power storage device is out of a specified range, said control device sets said first threshold value to a value lower than when said temperature is within said specified range.

4. The hybrid vehicle according to claim 1, wherein
as a temperature of said electric motor is higher, said control device sets said first threshold value to be lower.

5. The hybrid vehicle according to claim 1, further comprising:
a drive device driving said electric motor, wherein
as a temperature of said drive device is higher, said control device sets said first threshold value to be lower.

6. The hybrid vehicle according to claim 1, wherein
when said vehicle speed exceeds said first threshold value or when vehicle output exceeds a predetermined second threshold value, said control device causes said internal combustion engine to operate, and
said display device further displays said second threshold value together with said vehicle output.

7. The hybrid vehicle according to claim 6, further comprising:
a power storage device storing electric power to be supplied to said electric motor, wherein
as a state quantity indicating a state of charge of said power storage device is lower, said control device sets said second threshold value to be lower.

8. The hybrid vehicle according to claim 6, further comprising:
a power storage device storing electric power to be supplied to said electric motor, wherein
when a temperature of said power storage device is out of a specified range, said control device sets said second threshold value to a value lower than when said temperature is within said specified range.

9. The hybrid vehicle according to claim 6, wherein
as a temperature of said electric motor is higher, said control device sets said second threshold value to be lower.

10. The hybrid vehicle according to claim 6, further comprising:
a drive device driving said electric motor, wherein
as a temperature of said drive device is higher, said control device sets said second threshold value to be lower.

11. The hybrid vehicle according to claim 6, wherein
said display device displays said vehicle speed and said vehicle output in a two-dimensional area, and also displays an area at which said internal combustion engine is stopped in said two-dimensional area based on said first and second threshold values.

12. The hybrid vehicle according to claim 11, wherein
said display device further displays a contour line indicating that electric power consumption of said electric motor per unit traveling distance is substantially the same in the area at which said internal combustion engine is stopped.
